(19) United States
(12) Patent Application Publication
(10) Pub. No.: US 2013/0117299 A1
(43) Pub. Date: May 9, 2013

(54) SYSTEM AND METHOD FOR SHOWING COVER ART ON A DISPLAY

(71) Applicant: Anthony J. Kraatz, Madison Heights, MI (US)

(72) Inventor: Anthony J. Kraatz, Madison Heights, MI (US)

(73) Assignee: GM GLOBAL TECHNOLOGY OPERATIONS LLC, Detroit, MI (US)

(21) Appl. No.: 13/433,816

(22) Filed: Mar. 29, 2012

Related U.S. Application Data
(60) Provisional application No. 61/556,354, filed on Nov. 7, 2011.

(51) Int. Cl. G06F 17/30

(52) U.S. Cl. 707/769; 707/E17.014

(57) ABSTRACT

A graphical display system for an audio system that receives data from a personal electronic device is provided. The personal electronic device is associated with a specific song. The graphical display system includes a display and a control module. The control module is in communication with the display and the personal electronic device. The control module has a control module memory that contains a database. The database includes a plurality of songs and metadata of the plurality of songs that indicates a title, an artist, a specific album, and a cover art that corresponds to each of the plurality of songs. The control module includes control logic for establishing a short range wireless connection between the control module and the personal electronic device. The control module includes control logic for receiving audio data that is associated with the specific song through the short range wireless connection.

### CROSS-REFERENCES TO RELATED APPLICATIONS

This patent application claims priority to U.S. Provisional Patent Application Ser. No. 61/556,354 filed Nov. 7, 2011 which is hereby incorporated herein by reference in its entirety.

### FIELD OF THE INVENTION

Exemplary embodiments of the invention relate to a graphical display system for an audio system and, more particularly, to a graphical display system for showing a graphical image representing cover art of a specified song on a display.

### BACKGROUND

An individual may use a personal electronic device such as, for example, a smartphone or a portable media player, to play music. In one approach, music may be streamed from an Internet radio service such as, for example, Pandora® or Stitcher®. When using an Internet radio service, a graphical image that corresponds with a specific song that is currently being played is shown on a display. For example, the graphical image could indicate the specific song's artist, album, song title, genre, and associated cover art. In another approach, music may be saved on a memory of the personal electronic device as an audio file.

Individuals may use their personal electronic devices to play music in a vehicle. For example, the personal electronic device may be used to play music saved on the memory as an audio file or streamed from an Internet application installed on the personal electronic device over an in-vehicle audio system. The personal electronic device is in communication with a control module of the in-vehicle audio system through a short range wireless connection. The short range wireless connection is typically any type of wireless signal for exchanging data over relatively short distances such as, for example, a Bluetooth® signal. However, in the event the in-vehicle audio system plays music that is saved on the memory of the personal electronic device using the short range wireless connection, some of the data that is associated with the graphic image may not be shown. Specifically, the cover art that is associated with a specific song may not be shown on the display associated with the in-vehicle audio system.

In one example where the Bluetooth® specification is used as the short range wireless connection, a profile that is referred to as Audio Video Remote Control Profile (AVRCP) may be used to send data to the control module of the in-vehicle audio system indicating the specific song's artist, album, song title, and genre. However, some older versions of AVRCP (i.e. version 1.3) may not have the capability to send the data corresponding with the specific song's cover art to the in-vehicle audio system. Therefore, a user may only be able to view information such as a song's artist, album, song title, and genre, but with missing graphics. Only a limited number of personal electronic devices that are currently available support a version of AVRCP that allows for the data corresponding with the specific song's cover art to be sent to the in-vehicle audio system over the Bluetooth® connection. Moreover, the control module of the in-vehicle audio system may not support a version of AVRCP that allows for the data corresponding with the specific song's cover art to be sent over the Bluetooth® connection.

A wired connection such as, for example, a universal serial bus (“USB”) may also be used to send music from the memory of the personal electronic device to the control module of the in-vehicle audio system as well. However, when using the USB connection, the graphical image that is associated with the cover art of a specific song is shown on the display. Therefore, a user may perceive the wireless connection as having lower quality and less feature content then a wired connection because the cover art is not shown. A user may also perceive playing music saved on the memory of the personal electronic device as an audio file, or that is streamed using an Internet application (e.g., RDIO, TuneIN, or Soundcloud) as having lower quality than playing music streamed from an Internet radio service (e.g., Pandora® or Stitcher®), because the cover art is not shown. This is because the control module of the in-vehicle audio system may include native controls and special protocol for sending text and graphics for streaming only music from an Internet radio service, and not from other types of Internet applications. Accordingly, it is desirable to provide a graphical display system that has the capability to view a specific song's cover art in the event a short range wireless connection is used.

### SUMMARY OF THE INVENTION

In one exemplary embodiment of the invention, a graphical display system for an audio system that receives data from a personal electronic device is provided. The personal electronic device is associated with a specific song. The graphical display system includes a display and a control module. The control module is in communication with the display and the personal electronic device. The control module has a control module memory that contains a database. The database includes a plurality of songs and metadata of the plurality of songs that indicates a title, an artist, a specific album, and a cover art that corresponds to each of the plurality of songs. The control module includes control logic for establishing a short range wireless connection between the control module and the personal electronic device. The control module includes control logic for receiving audio data that is associated with the specific song through the short range wireless connection. The control module includes control logic for receiving a specific song title, a specific song artist, and a specific song album that is associated with the specific song through the short range wireless connection. The control module includes control logic for querying the database using the specific song title, the specific song artist, and the specific song album sent over the short range wireless connection with the plurality of songs stored in the database. The control module includes control logic for determining if the database includes an identical song that matches the specific song, where the title, the artist, and the specific album of the identical song match the specific song title, the specific song artist, and the specific song album of the specific song. The control module includes control logic for obtaining the cover art of the identical song from the database. The control module includes control logic for generating a graphical image data representing the cover art of the identical song that is shown on the display.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic diagram of an exemplary graphical display system for an audio system in a vehicle; and

FIG. 2 is a process flow diagram illustrating a method of operating the graphical display system as shown in FIG. 1.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

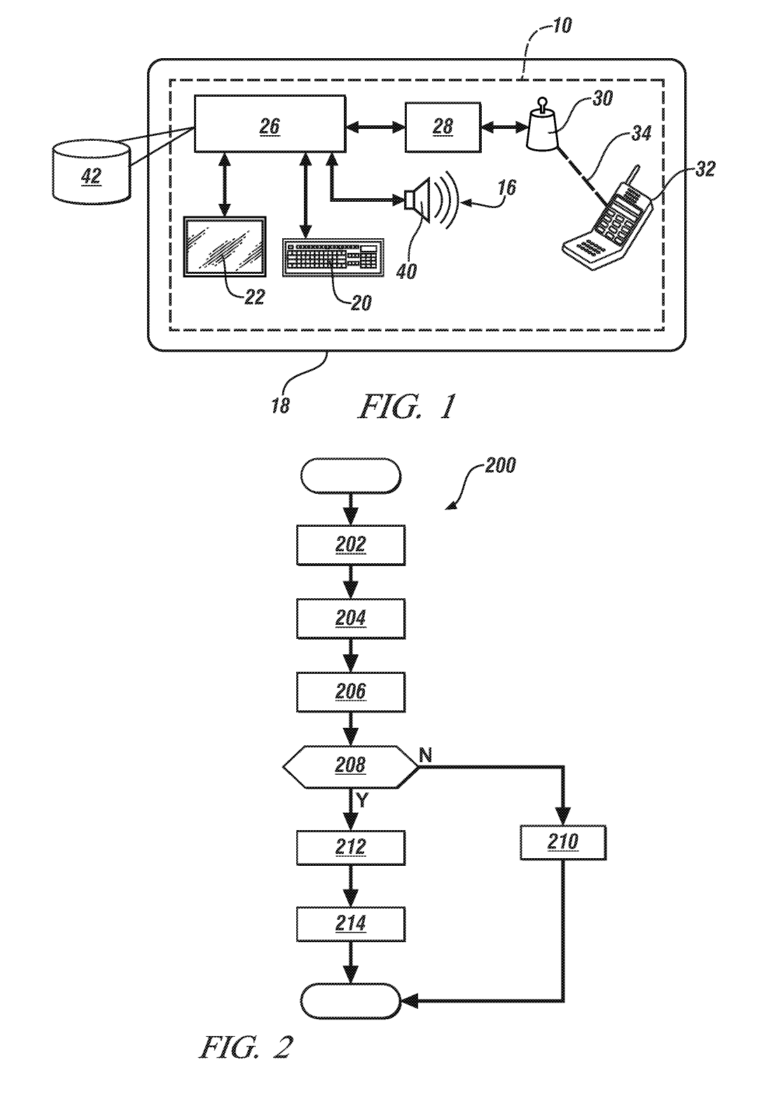

Referring now to FIG. 1, an exemplary embodiment is directed to a graphical display system 10 for an audio system 16 of a vehicle 18. The graphical display system 10 includes a user input 20, a display 22, a control module 26, a transceiver 28, an antenna 30, and a personal electronic device 32. The control module 26 is in communication with the personal electronic device 32 through the transceiver 28 and the antenna 30 by a short-range wireless connection 34. The short range wireless connection 34 is any type of wireless signal for exchanging data over distances under about 10 meters. In one example, the short-range wireless connection 34 may be a Bluetooth® signal conforming to IEEE Standard 802.15 or a Wi-Fi® signal conforming to IEEE standard 802.11. The personal electronic device 32 is situated within proximity of the antenna 30 such that short-range wireless communication may be achieved between the antenna 30 and the personal electronic device 32. That is, the personal electronic device 32 is usually situated within about 10 meters from the antenna 30, which is usually within an interior cabin (not shown in FIG. 1) of the vehicle 18. In the embodiment as shown in FIG. 1, the graphical display system 10 is employed in the vehicle 18. However it is to be understood that the graphical display system 10 may be employed in any variety of applications such as, for example, home audio receivers, computers, and mobile devices.

The personal electronic device 32 is generally any type of portable electronic device that has short range wireless capability, a memory for storing audio files, and/or the ability to stream an audio signal through an Internet application. Specifically, the personal electronic device 32 may download or install an application that allows for audio data to be streamed over a data connection such as, for example, a cellular data connection or a short-range wireless connection such as Wi-Fi®. For example, in one embodiment, the personal electronic device 32 may be a smartphone, or any type of telephone capable of storing audio files and/or receiving and playing steamed audio files from an Internet application. The personal electronic device 32 also includes short range wireless capabilities. In another embodiment, the personal electronic device 32 is a portable media player, a portable navigation device, a tablet computer, or a laptop computer. The audio files (stored in the memory of the personal electronic device 32) and the audio signal (streamed over a data connection) each contain digitized audio data. In addition to the digitized audio data, the audio files or the audio signal also include accompanying information or metadata that is associated with a specific audio file. That is, a specific audio file includes digitized audio data that represents a song or other audio recording, as well as information that is associated with the song such as, for example, the title of the song, the artist, the specific album, the cover art, and the genre of music that is associated with the song. For example, in one embodiment an ID3 metadata tag may be used to identify the information that is associated with the song if MPEG-2 Audio Layer III (“MP3”) files are employed, however it is to be understood that other types of audio files having metadata such as, for example, a Windows media audio (“WMA”) file or an advanced audio coding (“AAC”) file may be used as well.

The user input 20 typically includes a keypad or a keyboard for allowing a user to input information. In one embodiment, the display 22 is a liquid crystal display (“LCD”) screen, and is used to display graphics and text. In one embodiment, the display 22 may have color display capability. The control module 26 is in communication with the user input 20, the display 22, the transceiver 28, the antenna 30 and at least one speaker 40. The audio system 16 of the vehicle 18 includes the speaker 40. Although FIG. 1 illustrates the transceiver 28 and the antenna 30 as separate components from the control module 26, it is to be understood that the transceiver 28 and the antenna 30 could also be integrated with the control module 26 as well. The control module 26 is any type of control module that may be used to play music over the audio system 16 of the vehicle 18. For example, in one embodiment the control module 26 is a radio control module for a radio such as, for example, a connected color radio. A color connected radio is generally any type of radio having a display that shows graphics in color.

The control module 26 includes a memory, where a database 42 is stored on the memory of the control module. The database 42 is a music media database storing the metadata of a number of songs that are currently available. The metadata may include at least the title of the song, the artist, the specific album, the cover art, and the genre of music that is associated with the song. For example, in one embodiment, the memory of the control module 26 stores a Gracenote® music database that stores the metadata of over one billion songs. However, it is to be understood that other types of music databases may be used as well. Also, in one embodiment, the memory of the control module 26 may be periodically updated to include new song releases and to make any corrections to the current database 42.

The control module 26 includes control logic for establishing the short range wireless connection 34 with the personal electronic device 32. The control module 26 includes control logic for receiving data over the short range wireless connection 34 containing the digitized audio data that is associated with a specific song, as well as the accompanying metadata that is associated with the specific song. Specifically, the metadata includes at least the title, the artist, the specific album, and the genre that is associated with the specific song. However, the metadata does not include the corresponding cover art that is associated with the specific song.

The control module 26 includes control logic for looking up or querying the database 42 using at least the title, the artist, and the specific album that is associated with the specific song that is sent over the short range wireless connection 34 from the personal electronic device 32. The control module 26 further includes control logic to determine if there is a matching or identical song that is stored in the database 42. That is, the control module 26 includes control logic for querying the database 42 for an identical song having the same title, artist, and specific album as the specific song that is sent over the short range wireless connection 34. Other factors such as, for example, the genre of the specific song may be used as well.

In the event that the database 42 does not include the identical song having the same title, artist, and album, then the control module 26 includes control logic for showing a default icon on the display 22. That is, the control module 26 includes control logic for generating graphical image data representing a default icon that is shown on the display 22. For example, in the event that a Bluetooth® wireless connection is used, then a Bluetooth® default icon may be shown on the display 22. In another approach, if the genre of the specific song is transmitted over the short range wireless connection 34 from the personal electronic device 32, then the control module 26 includes control logic for displaying a default genre graphic. For example, if the specified song is of the rock genre, a guitar may be displayed as the cover art.

In the event the database 42 includes the identical song having the same title, artist, and album, then the control module 26 includes control logic for obtaining the corresponding cover art of the identical song from the database 42. That is, the database 42 includes or stores the metadata representing the cover art that is associated with the identical song. The control module 26 includes control logic for generating graphical image data that is shown on the display 22 representing the cover art.

A method of operating the graphical display system 10 will now be explained. Referring to FIG. 2, an exemplary process flow diagram illustrating an exemplary process of operating the graphical display system 10 is generally indicated by reference number 200. Referring to both FIGS. 1-2, process 200 begins at step 202, where a control module 26 (shown in FIG. 1) includes control logic for establishing a short-range wireless connection 34 between the control module 26 and a personal electronic device 32. Process 200 may then proceed to step 204.

In step 204, the control module 26 includes control logic for receiving data over the short range wireless connection 34 containing the digitized audio data that is associated with a specific song, as well as the accompanying metadata that is associated with the specific song. Specifically, the metadata includes at least the title, the artist, the specific album, and the genre that is associated with the specific song, but does not include the corresponding cover art that is associated with the specific song. Process 200 may then proceed to step 206.

In step 206, the control module 26 includes control logic for looking up or querying a database 42 using at least the title, the artist, and the specific album that is associated with the specific song that is sent over the short range wireless connection 34 from the personal electronic device 32. Process 200 may then proceed to step 208.

In step 208, the control module 26 includes control logic for determining if the database 42 includes an identical song having the same title, artist, and specific album as the specific song that is sent over the short range wireless connection 34. If the database 42 does not include the identical song having the same title, artist, and album, then process 200 proceeds to step 210. In step 210, the control module 26 includes control logic for generating a graphical image data representing a default icon that is shown on a display 22. Process 200 may then terminate. If the database 42 includes the identical song having the same title, artist, and album, then process 200 may then proceed to step 212. In step 212, the control module 26 includes control logic for obtaining the corresponding cover art of the identical song from the database 42. Process 200 may then proceed to step 214.

In step 214, the control module 26 includes control logic for generating graphical image data that is shown on the display 22 representing the cover art. Process 200 may then terminate.

The graphical display system 10 as illustrated in FIGS. 1-2 is generally employed in the event that the short range wireless connection 32 does not have the capability to send data corresponding with a specific song's cover art to the control module 26. Specifically, for example, if the Bluetooth® specification employed, a profile that is referred to as Audio Video Remote Control Profile (AVRCP) may be employed. However, some older versions of AVRCP (i.e. version 1.3) may not have the capability to send the data corresponding with the specific song's cover art to the control module 26. Therefore, the control module 26 includes the database 42 for providing the specific song's cover art to the control module 26. This in turn may improve customer satisfaction, as a user may perceive the Bluetooth® connection as having comparable quality and the same feature content as a wired connection because the cover art is shown on the display 22. Moreover, a user may also perceive playing audio files saved on the memory of the personal electronic device 32 as an audio file having comparable quality to music streamed from an Internet radio service (e.g., Pandora®) because cover art is shown on the display 22. Additionally, a user may also perceive playing audio files that are streamed from an Internet application as having comparable quality to music streamed from an Internet radio service as well.

The graphical display system 10 may especially enhance user satisfaction in the event a user has a personal electronic device 32 that does not have the capability to stream music from an Internet radio service such as, for example, Pandora® or Stitcher®. The graphical display system 10 may also enhance user satisfaction in the event a wired connection such as, for example, a universal serial bus (“USB”) is not available to send data from the personal electronic device 32 to the control module 26.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A graphical display system for an audio system that receives data from a personal electronic device, the personal electronic device associated with a specific song, the graphical display system comprising:
a display; and
a control module that is in communication with the display and the personal electronic device, the control module having a control module memory that contains a database, the database including a plurality of songs and metadata of the plurality of songs that indicates a title, an artist, a specific album, and a cover art that corresponds to each of the plurality of songs, the control module having:
a control logic for establishing a short range wireless connection between the control module and the personal electronic device;
a control logic for receiving audio data that is associated with the specific song through the short range wireless connection;
a control logic for receiving a specific song title, a specific song artist, and a specific song album that is associated with the specific song through the short range wireless connection;
a control logic for querying the database using the specific song title, the specific song artist, and the specific song album sent over the short range wireless connection with the plurality of songs stored in the database;
a control logic for determining if the database includes an identical song that matches the specific song, wherein the title, the artist, and the specific album of the identical song match the specific song title, the specific song artist, and the specific song album of the specific song;
a control logic for obtaining the cover art of the identical song from the database; and
a control logic for generating a graphical image data representing the cover art of the identical song that is shown on the display.

2. The graphical display system as recited in claim 1, wherein the control module includes control logic for generating a default graphical image representing a default icon that is shown on the display if the database does not include the identical song that matches the specific song,

3. The graphical display system as recited in claim 2, wherein the control module includes control logic for receiving a specific genre that is associated with the specific song through the short range wireless connection.

4. The graphical display system as recited in claim 3, wherein the default icon is dependent on the specific genre of the specific song.

5. The graphical display system as recited in claim 1, wherein the short-range wireless connection conforms to one of IEEE Standard 802.15 and IEEE Standard 802.11.

6. The graphical display system as recited in claim 1, wherein the personal electronic device is one of a smartphone, portable media player, a portable navigation device, a tablet computer, and a laptop computer.

7. The graphical display system as recited in claim 1, wherein the control module is a radio control module for a vehicle.

8. A vehicle having a graphical display system, the graphical display system having an audio system that receives data from a personal electronic device, the personal electronic device associated with a specific song, the graphical display system comprising:
a display; and
a control module that is in communication with the display and the personal electronic device, the control module having a control module memory that contains a database, the database including a plurality of songs and metadata of the plurality of songs that indicates a title, an artist, a specific album, and a cover art that corresponds to each of the plurality of songs, the control module having:
a control logic for establishing a short range wireless connection between the control module and the personal electronic device;
a control logic for receiving audio data that is associated with the specific song through the short range wireless connection;
a control logic for receiving a specific song title, a specific song artist, and a specific song album that is associated with the specific song through the short range wireless connection;
a control logic for querying the database using the specific song title, the specific song artist, and the specific song album sent over the short range wireless connection with the plurality of songs stored in the database;
a control logic for determining if the database includes an identical song that matches the specific song, wherein the title, the artist, and the specific album of the identical song match the specific song title, the specific song artist, and the specific song album of the specific song;
a control logic for obtaining the cover art of the identical song from the database; and
a control logic for generating a graphical image data representing the cover art of the identical song that is shown on the display.

9. The vehicle as recited in claim 8, wherein the control module includes control logic for generating a default graphical image representing a default icon that is shown on the display if the database does not include the identical song that matches the specific song.

10. The vehicle as recited in claim 9, wherein the control module includes control logic for receiving a specific genre that is associated with the specific song through the short range wireless connection.

11. The vehicle as recited in claim 10, wherein the default icon is dependent on the specific genre of the specific song.

12. The vehicle as recited in claim 8, wherein the short-range wireless connection conforms to one of IEEE Standard 802.15 and IEEE Standard 802.11.

13. The vehicle as recited in claim 8, wherein the personal electronic device is one of a smartphone, portable media player, a portable navigation device, a tablet computer, and a laptop computer.

14. The vehicle as recited in claim 8, wherein the control module is a radio control module.

15. A method of showing images on a display, comprising:
providing a personal electronic device associated with a specific song;
providing a control module that is in communication with the display and the personal electronic device, the control module having a control module memory that contains a database, the database including a plurality of songs and metadata of the plurality of songs that indicates a title, an artist, a specific album, and a cover art that corresponds to each of the plurality of songs;
establishing a short range wireless connection between the control module and the personal electronic device;
receiving audio data that is associated with the specific song through the short range wireless connection by the control module;
receiving a specific song title, a specific song artist, and a specific song album that is associated with the specific song through the short range wireless connection;
querying the database using the specific song title, the specific song artist, and the specific song album sent over the short range wireless connection with the plurality of songs stored in the database;
determining if the database includes an identical song that matches the specific song, wherein the title, the artist, and the specific album of the identical song match the specific song title, the specific song artist, and the specific song album of the specific song;
obtaining the cover art of the identical song from the database; and
generating a graphical image data representing the cover art of the identical song that is shown on the display.

16. The method as recited in claim 15, comprising generating a default graphical image representing a default icon that is shown on the display if the database does not include the identical song that matches the specific song,

17. The method as recited in claim 16, comprising receiving a specific genre that is associated with the specific song through the short range wireless connection by the control module.

18. The method as recited in claim 17, wherein the default icon is dependent on the specific genre of the specific song.

19. The method as recited in claim 15, wherein the short-range wireless connection conforms to one of IEEE Standard 802.15 and IEEE Standard 802.11.

20. The method as recited in claim 15, wherein the personal electronic device is one of a smartphone, portable media player, a portable navigation device, a tablet computer, and a laptop computer.
